(19) United States
(12) Patent Application Publication
(10) Pub. No.: US 2011/0152438 A1
(43) Pub. Date: Jun. 23, 2011

(54) USE OF ALDEHYDE CONDENSATES AS DRYING AIDS IN FORMULATIONS BASED ON MINERAL BINDERS

(75) Inventors: Sebastien Garnier, Weinheim (DE); Corinna Naundorf, Mannheim (DE); Ulf Dietrich, Ludwigshafen (DE)

(73) Assignee: BASF SE, LUDWIGSHAFEN (DE)

(21) Appl. No.: 13/056,792

(22) PCT Filed: Aug. 10, 2009
(86) PCT No.: PCT/EP09/60334

§ 371 Date: Jan. 31, 2011

(30) Foreign Application Priority Data
Aug. 15, 2008 (EP) 08162459.5

(51) Int. Cl. C08L 61/06

(52) U.S. Cl. 524/510

(57) ABSTRACT

A method of drying a polymer dispersion, wherein a C₂-C₆-mono- and/or dialdehyde condensate with sulfonated phenols, naphthalenes or sulfonated polynuclear aromatics, alone or mixtures thereof, is contacted with an aqueous polymer dispersion.

The present invention relates to the use of C₂-C₆-mono- and/or dialdehyde condensates with sulfonated phenols, sulfonated naphthalenes and other sulfonated polynuclear aromatics as drying aids, in particular in the spray drying of aqueous polymer dispersions for mineral building materials, such as gypsum, cement or mortar.

The present invention furthermore relates to mineral building materials comprising the aldehyde condensates according to the invention.

Aqueous polymer dispersions are widely used, for example as binders, in particular for synthetic resin renders or highly pigmented interior paints, adhesives, concrete, mortar or coating materials. Frequently, however, it is desired to use not the aqueous polymer dispersion but the polymer in powder form.

In order to obtain the polymer in powder form, the dispersion must be subjected to a drying process, for example spray drying or freeze drying. In spray drying, the polymer dispersion is sprayed in a warm air stream and dried, the dry air and the sprayed dispersion preferably being fed cocurrently through the dryer.

However, the polymer powder obtained has the disadvantage that its redispersibility in an aqueous medium is generally not completely satisfactory because the diameter distribution of the polymer particles which results on redispersing is as a rule different from that in the aqueous starting dispersion. The reason for this is that aqueous polymer dispersions, in contrast to polymer solutions, do not form thermodynamically stable systems. Rather, the system attempts to reduce the polymer/dispersing medium interface by combining small primary particles to give larger secondary particles (specks, coagulum). In the state of the disperse distribution in the aqueous medium, this can be prevented even for a relatively long time by addition of dispersants, such as emulsifiers and protective colloids. During the drying of aqueous polymer dispersions, however, the effect of the dispersions is frequently not sufficient and irreversible secondary particle formation occurs to a certain extent. This means that the secondary particles are retained on redispersing and reduce the performance characteristics of the aqueous polymer dispersion obtainable in the course of redispersing.

In order to prevent or at least to reduce the secondary particle formation on drying, it has long been known to use so-called drying aids. This is often referred to as spraying aids since spray drying particularly promotes the formation of irreversibly agglomerated secondary particles. This effect is all the more pronounced the lower the glass transition temperature (and hence the softening temperature or the minimum film formation temperature) of the polymer particles, particularly when it is below the drying temperature. At the same time, drying aids generally reduce the formation of polymer coating remaining adhering to the dryer wall and thus result in an increase in the powder yield.

The use of drying aids is known from numerous publications. Thus, DE-A-24 45 813 describes a pulverulent polymer which is redispersible in aqueous systems and comprises, as a drying aid, from 1 to 20% by weight of a water-soluble condensate of aromatic hydrocarbons and formaldehyde, which condensate contains sulfo or sulfonate groups. These condensates are in particular phenolsulfonic acid- or naphthalenesulfonic acid-formaldehyde condensates.

EP-A 078 449 describes a process for the preparation of blocking-resistant, water-redispersible polymer powders by spray drying of aqueous dispersions of polymers having glass transition temperatures below 50° C. The dispersions comprise, as a spraying aid, a water-soluble copolymer of vinylpyrrolidone and vinyl acetate and/or a water-soluble alkali metal and/or alkaline earth metal salt of a naphthalenesulfonic acid-formaldehyde condensate.

Similarly, EP-A 407 889 describes the use of a water-soluble alkali metal or alkaline earth metal salt of a phenolsulfonic acid-formaldehyde condensate as a spraying aid for the preparation of water-redispersible polymer powders from aqueous polymer dispersions.

WO 2005/021145 discloses the use of o-cresolsulfonic acid-formaldehyde condensates as dispersants.

Disadvantages of the spraying aids disclosed in the prior art are firstly the use of formaldehyde and secondly the coloration of the spray-dried powder which occurs with the use of phenolsulfonic acid-formaldehyde condensates.

It is the object of the present invention to provide drying aids for use in mineral building materials which permit the preparation, from polymer dispersions, of polymer powders which are readily redispersible in water and do not have the disadvantages of the prior art.

Surprisingly, it was found that this object is achieved if C₂-C₆-aldehyde condensates with sulfonated aromatics are used. In addition, the C₂-C₆-aldehyde condensates exhibit less retardation in the hydration of cement.

The present invention therefore relates to the use of C₂-C₆-aldehyde condensates as aids in the drying of aqueous polymer dispersions in mineral building materials.

The preparation of the drying aids used according to the invention is effected as a rule by condensation of the C₂-C₆-aldehydes with sulfonated phenols, sulfonated naphthalenes or other sulfonated polynuclear aromatics under acidic reaction conditions, in particular in the presence of sulfuric acid. Phenols are understood as meaning, for example, phenol, ortho-cresol, meta-cresol, para-cresol, 2-ethylphenol, 3-ethylphenol, 4-ethylphenol, 2,3-dimethylphenol, 2,4-dimethylphenol, 2,5-dimethylphenol, 2,6-dimethylphenol, 3,4-dimethylphenol, 3,5-dimethylphenol, 3,4,5-trihydroxybenzoic acid; naphthalenes are understood as meaning those which may be unsubstituted, monosubstituted and polysubstituted. If one or more substituents are present, these are selected, independently of one another, from, for example, C₁-C₁₀-alkyl groups, such as, for example, methyl, ethyl, n-propyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or from other groups such as hydroxyl, methoxy, ethoxy, amino, dimethylamino, ethylmethylamino, diethylamino. Related compounds may be, for example, benzene, toluene, ortho-xylene, meta-xylene, para-xylene, ethylbenzene, cumene, para-methylcumene, biphenyl, 2-methylbiphenyl, 3-methylbiphenyl, 4-methylbiphenyl, para-terphenyl, indene, fluorene, phenanthrene, anthracene, 9-methylanthracene, 9-phenyl-anthracene. The sulfonated phenols, sulfonated naphthalenes or other sulfonated polynuclear aromatics can be initially taken or prepared in situ by known methods (cf. J. March, Advanced Organic Chemistry, 3^{rd} ed, John Wiley, New York 1985, p. 473 et seq., and literature cited there). For example, phenolsulfonic acid or naphthalene-sulfonic acid is preferably prepared in situ by sulfonation with sulfuric acid, preferably concentrated sulfuric acid. The condensation is effected by reacting the sulfonated phenols or sulfonated naphthalenes or other sulfonated polynuclear aromatics with the C₂-C₆-aldehydes under acidic reaction conditions, preferably under reaction conditions involving the presence of sulfuric acid, in particular in concentrated sulfuric acid. If, for example, the phenolsulfonic acid or naphthalenesulfonic acid is prepared in situ, the condensation is initiated by addition of the C₂-C₆-aldehydes to the reaction mixture comprising sulfuric acid. The molar aldehyde:phenolsulfonic acid ratio is in the range from 1:1 to 1:2, preferably in the range from 1:1.3 to 1:1.7. Preferably, the C₂-C₆-aldehyde is added as an aqueous solution. In order to establish the desired molecular weight, the condensation reaction is carried out as a rule at temperatures in the range from 90 to 110° C., preferably at about 100° C. The duration of the reaction is as a rule from 2 to 6 h, preferably from 3 to 5 h. If the salts are desired as drying aids, neutralization with a suitable basic metal salt or an amine is carried out after the condensation, both metal salt and amine preferably being used as an aqueous solution or dispersion.

The amount of drying aids used is preferably from 1 to 30% by weight, based on the weight of polymer of the dispersion, preferably from 3 to 15% by weight and particularly preferably from 5 to 12% by weight.

The compounds according to the invention are particularly advantageous for drying polymer dispersions in which the polymer has a glass transition temperature (DSC, midpoint temperature, ASTM D 3418-82) of from +115° C. to −60° C., preferably ≦65° C., particularly preferably ≦50° C., especially particularly preferably 25° C. and very particularly preferably ≦0° C. In general, the glass transition temperature of the polymers is ≧−60° C., preferably ≧−40° C. and in particular ≧−20° C.

It is often helpful to estimate the glass transition temperature T_{g} of the dispersed polymer (T. G. Fox, Bull. Am. Phys. Soc. (Ser. II) 1, 123 [1956] and Ullmanns Encyklopädie der technischen Chemie, Weinheim (1980), pp. 17, 18).

Aldehyde condensates having a number average molecular weight Mₙ of <1500 dalton are advantageously used as drying aids.

The present invention therefore relates to the use of aldehyde condensates having a number average molecular weight Mₙ of <1500 dalton or salts thereof as aids in the drying of aqueous polymer dispersions.

Preferably, the condensates have average molecular weights Mₙ in the range from 500 to 1500 dalton, in particular from 600 to 1200 dalton, determined by means of gel permeation chromatography as described in the examples in the case of the preparation of the spraying aids. The nonuniformity (defined as M_{w}/Mₙ) is in the range from 5 to 15, preferably in the range from 5 to 11. The proportion of condensates having molar masses above 10 000 dalton preferably accounts for less than 25% by weight, in particular less than 20% by weight, of the total condensate.

If the condensate is used in the form of its salts, as a rule alkali metal or alkaline earth metal salts or ammonium salts are used, i.e. salts with ammonia or organic amines, such as triethanolamine, diethanolamine or triethylamine. The alkaline earth metal salts and in particular the calcium salts are preferred.

The polymers to be dried are preferably polymers which comprise
(a) from 80 to 100% by weight of at least one monomer which is selected from vinylaromatic compounds, esters of α,β-monoethylenically unsaturated C₃-C₆-carboxylic acids and C₁-C₁₂-alkanols, preferably C₁-C₈-alkanols, vinyl and allyl esters of C₁-C₁₅-carboxylic acids and butadiene, and
(b) from 0 to 20% by weight of at least one other monomer which has at least one ethylenically unsaturated group.

Here, the expressions Cₙ-Cₘ relate to the number of carbons of the respective class of compounds which is possible in the context of the invention. Alkyl groups may be linear or branched. Cₙ-Cₘ-Alkylaryl represents aryl groups which carry a Cₙ-Cₘ-alkyl radical.

Examples of vinylaromatic compounds are styrene, α-methylstyrene or vinyltoluenes, such as o-vinyltoluene.

The esters of α,β-monoethylenically unsaturated carboxylic acids are in particular esters of acrylic acid, methacrylic acid, maleic acid, fumaric acid or itaconic acid. Examples of such esters are methyl (meth)acrylate, ethyl (meth)acrylate, n-butyl (meth)acrylate, isobutyl (meth)acrylate, tert-butyl (meth)acrylate, ethylhexyl (meth)acrylate, decyl (meth)acrylate or dodecyl (meth)acrylate.

Vinyl and alkyl esters which can be used are vinyl acetate, vinyl propionate, vinyl n-butyrate, vinyl laurate and vinyl versatates and the corresponding allyl esters.

Particularly preferred monomers (a) are n-butyl acrylate, 2-ethylhexyl acrylate, methyl methacrylate and styrene.

The monomers (b) are preferably the abovementioned α,β-monoethylenically unsaturated C₃-C₆-carboxylic acids and the corresponding nitriles, amides, mono- or dialkylamides and hydroxyalkyl esters thereof. N-Vinyl derivatives of cyclic lactams and the mono- or dialkylaminoalkylamides of the C₃-C₆-carboxylic acids mentioned and the quaternization products thereof, such as, for example, trialkylammoniumalkyl (meth)acrylates and trialkylammoniumalkyl (meth)acrylamides, are also suitable.

Particularly preferred monomers (b) are acrylamide, methacrylamide, acrylic acid, methacrylic acid, acrylonitrile, methacrylonitrile, 2-acrylamido-2-methylpropanesulfonic acid, vinylpyrrolidone, hydroxyethyl acrylate, hydroxyethyl methacrylate, hydroxypropyl acrylate, hydroxypropyl methacrylate, quaternized vinylimidazole, N,N-dialkylaminoalkyl (meth)acrylates, N,N-dialkylaminoalkyl(meth)acrylamides, trialkylammoniumalkyl (meth)acrylates and trialkylammoniumalkyl(meth)acrylamides.

Preferred polymer dispersions are furthermore those in which the weight average diameter d_{w} of the dispersed polymer particles is ≧100 nm and particularly preferably ≧300 nm. Usually, d_{w} is ≦2000 nm. It is furthermore advantageous if the diameters of the dispersed polymer particles are distributed over a broad diameter range.

The d_{w} value of the particle size is defined, as usual, as the weight average of the particle size as determined by means of an analytical ultracentrifuge according to the method of W. Scholtan and H. Lange, Colloid-Z. and Z.-Polymere 250 (1972) pages 782 to 796. The ultracentrifuge measurement gives the integral mass distribution of the particle diameter of a sample. From this, it is possible to derive the percentage by weight of the particles which have a diameter equal to or less than a certain size.

A suitable measure for characterizing the width of the diameter distribution is the quotient Q=(d₉₀−d₁₀)/d₅₀, where dₘ is the diameter which is not exceeded by m % by weight of the dispersed polymer particles. Preferably, Q is from 0.5 to 1.5. The preparation of polymer dispersions having such a particle distribution width is known to the person skilled in the art, for example from DE-A 43 07 683.

The ratio of weight average molecular weight M_{w} to number average molecular weight Mₙ of the polymers may be from 1 to 30 or from 1 to 20 or from 1 to 8. The molecular weight can thus be substantially uniform or distributed over a certain width.

The preparation of the polymer dispersions to be dried is known. In general, it is effected by free radical polymerization, which is preferably carried out in polar solvents, in particular in water. For establishing the desired molecular weight, substances which regulate the molecular weight can be concomitantly used. Suitable molecular weight regulators are, for example, compounds which have a thiol group and/or a silane group (e.g. t-dodecyl or n-dodecyl mercaptan or mercaptopropyltrimethoxysilane), allyl alcohols or aldehydes, such as acetaldehyde, etc.

Suitable initiators are, for example, organic or inorganic peroxides, such as potassium, sodium or ammonium peroxodisulfate or water- and monomer-soluble azo compounds, such as azobisisobutyronitrile, azobiscyanovaleric acid and 2,2′-azobis(2-methylpropionamidine) dihydrochloride, redox initiator systems consisting of an oxidizing agent, such as hydrogen peroxide, tert-butyl hydroperoxide, tert-butyl peroxide, and reducing agents, such as, for example, potassium, sodium or ammonium sulfite and bisulfite and ascorbic acid, it also being possible to use solely oxidizing agents which can form free radicals by means of thermal decomposition, and catalytic initiator systems, such as, for example, the system H₂O₂/Fe²⁺/H⁺. The proportion of initiators, based on the proportion of monomers, is preferably from 0.01 to 5% by weight, in particular from 0.1 to 3% by weight. The polymerization can be effected as solution or emulsion polymerization, depending on the monomer composition.

If the polymer dispersion is prepared by emulsion polymerization, this is effected in a customary manner. In general, a protective colloid, such as polyvinyl alcohol, polyvinylpyrrolidone or cellulose derivatives or anionic and/or nonionic emulsifiers, such as ethoxylated mono-, di- or trialkylphenols, ethoxylated fatty alcohols and alkali metal or ammonium salts of C₈-C₁₂-alkyl sulfates, sulfuric acid monoesters of ethoxylated C₁₂₋₁₈-alkanols, C₁₂-C₁₈-alkanesulfonic acids, C₉-C₁₈-alkylarylsulfonic acids and sulfonated alkyldiphenyl ethers are generally used. The polymerization temperature is in general in the range from 30 to 120° C., in particular from 70 to 100° C.

The dispersion may be a primary dispersion, i.e. a polymer dispersion which was obtained directly by the free radical, aqueous emulsion polymerization method. It may also be a secondary dispersion, i.e. a polymer obtained by solution polymerization is subsequently converted into an aqueous polymer dispersion.

The drying of the polymer dispersion can be effected in the customary manner, for example by freeze drying or preferably by spray drying. In the case of spray drying, a procedure is adopted in which the entry temperature of the warm air stream is in the range from 100 to 200° C., preferably from 120 to 160° C., and the exit temperature of the warm air stream is in the range from 30 to 90° C., preferably from 60 to 80° C. The spraying of the aqueous polymer dispersion in the warm air stream can be effected, for example, by means of single-material or multimaterial nozzles or via a rotating disk. The deposition of the polymer powder is usually effected with the use of cyclones or filter separators. The sprayed aqueous polymer dispersion and the warm air stream are preferably fed parallel.

The aldehyde condensates used according to the invention can be added prior to the drying as aqueous solution or as solid to the dispersion to be dried. If it is a primary dispersion, the drying aid can be added before, during and/or after the emulsion polymerization.

For example, acetaldehyde, propionaldehyde, butyraldehyde, isobutyraldehyde, glyoxal, glutaraldehyde, pentanal or hexanal and the isomeric compounds thereof and corresponding aldehyde mixtures with sulfonated phenols, sulfonated naphthalenes and other sulfonated polynuclear aromatics are used as C₂-C₆-aldehyde condensates according to the invention.

Phenols are understood as meaning, for example, phenol, ortho-cresol, meta-cresol, para-cresol, 2-ethylphenol, 3-ethylphenol, 4-ethylphenol, 2,3-dimethylphenol, 2,4-dimethylphenol, 2,5-dimethylphenol, 2,6-dimethylphenol, 3,4-dimethylphenol, 3,5-dimethylphenol, 3,4,5-trihydroxybenzoic acid; naphthalenes and dihydroxyphenyl sulfones are understood as meaning those which may be unsubstituted, monosubstituted and polysubstituted. If one or more substituents are present, these are selected, independently of one another, from, for example, C₁-C₁₀-alkyl groups, such as, for example, methyl, ethyl, n-propyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl, or from other groups, such as hydroxyl, methoxy, ethoxy, amino, dimethylamino, ethylmethylamino, diethylamino. The term phenol is also understood as meaning related compounds, for example benzene, toluene, ortho-xylene, meta-xylene, para-xylene, ethylbenzene, cumene, para-methylcumene. The polynuclear aromatics are understood as meaning, for example, biphenyl, 2-methylbiphenyl, 3-methylbiphenyl, 4-methylbiphenyl, para-terphenyl, indene, fluorene, phenanthrene, anthracene, 9-methylanthracene or 9-phenylanthracene.

In addition to the drying aids according to the invention, known drying aids, such as polyvinyl alcohol, polyvinylpyrrolidone, homopolymers of 2-acrylamido-2-methyl-propanesulfonic acid, etc., may additionally be concomitantly used. Anticaking agents, such as finely divided silica, which are usually used for the drying of aqueous polymer dispersions can also be used for preventing caking of the polymer powder during storage. In the case of spray drying, the anticaking agents are as a rule sprayed in separately.

The present invention also relates to the polymer powders obtainable according to the invention. They are suitable as binders in mineral building materials, paints, finishes and adhesives and synthetic resin renders, as described in EP-A 629 650, but in particular for mineral building materials.

In the context of the present invention, mineral building materials are understood as meaning, for example, inorganic, as a rule mineral substances which, when mixed with water, harden to give a solid. Here, a distinction is made between substances which harden with water (latently hydraulic binders), e.g. gypsum or gypsum-containing formulations, such as modeling plaster, stucco or plaster for rendering, molding plaster, plaster floor, Sorel cement, magnesium binder and white lime, and hydraulic binders, such as lime, cement or mortar. The term “gypsum” used here comprises both anhydrite and calcium sulfate hemihydrate.

Typically, the dry mortars comprise, based on the amount of mineral binder, from 0.1 to 200% by weight of modified polymer powder.

For improving their processing properties, cellulose derivatives and microsilica are often added to the dry mortars. As a rule, calcium carbonate and quartz sand form the customary additives. By addition of antifoams (preferably in powder form with respect to “dry mortar”), an air void content (from 1 to 20% by volume) of the solidified cement-containing mortar which is suitable in practice can be achieved in the solidified state.

The following examples illustrate the invention without limiting it.

### EXAMPLES

### Dispersion

A mixture of

150 g of water
5.6 g of a 20% strength by weight aqueous solution of an ethoxylated p-isooctylphenol (degree of EO 25),
0.48 g of a 35% by weight aqueous solution of a sodium salt of a sulfated and an ethoxylated p-isooctylphenol (degree of EO 25),
3.9 g of a 10% strength by weight aqueous formic acid solution,
1.7 g of sodium bicarbonate and
3.4 g of a 20% strength by weight aqueous polyacrylamide solution
was heated to 90° C. Thereafter, beginning at the same time and while maintaining the internal temperature of 90° C., 742.8 g of an aqueous monomer emulsion consisting of
291.2 g of n-butyl acrylate,
250.0 g of styrene,
11.2 g of acrylamide,
8.4 g of a 20% strength by weight aqueous solution of an ethoxylated p-isooctylphenol (degree of EO 25),
11.5 g of a 20% strength by weight aqueous solution of a sodium salt of a sulfated and ethoxylated p-isooctylphenol (degree of EO 25) and
162.9 g of water
were continuously added to this mixture dropwise in 2 h and a solution of 3.3 g of sodium peroxodisulfate in 90 g of water in 2.5 h. Thereafter, the reaction mixture was stirred for a further 120 min at 90° C. and cooled to 60° C. After the addition of a solution of 1.1 g of tert-butyl hydroperoxide in 5.5 g of water, a solution of 0.6 g of sodium hydroxymethanesulfinate in 15 g of water was added at this temperature in the course of 1 h and stirring was effected for a further 0.5 h. After 15 min, cooling to room temperature was achieved and neutralization with 3.5 g of a 10% strength by weight aqueous ammonia solution was effected. After filtration, a dispersion having a solids content of 54.5%, a light transmittance of a 0.01% strength by weight dispersion at 20° C. and a layer thickness of 2.5 cm (LT value) of 9% and a pH of 7.3 was obtained. The glass transition temperature (DSC midpoint, see above) of the polymer was +15° C.

The solids content of the polymer dispersion obtained was 58.7%, the LT value was 17%, the Tg^{Fox} was 7° C. and the pH was 7.2.

### Preparation of the Spraying Aid According to the Invention and of the Comparative Spraying Aid

### General Preliminary Remarks:

The molecular weight determinations are carried out by gel permeation chromatography (GPC):
Stationary phase: poly(2-hydroxymethacrylate) gel crosslinked with ethylene glycol dimethacrylate, commercially available as HEMA BIO from PSS, Mainz, Germany.
Mobile phase: mixture of 30% by weight of tetrahydrofuran (THF), 10% by weight of acrylonitrile, 60% by weight of 1 molar NaNO₃ solution
Internal standard: 0.001% by weight of benzophenone, based on mobile phase Flow rate: 1.5 ml/min
Concentration: 1% by weight in a mobile phase with internal standard
Detection: UV/Vis spectrometry at 254 nm
Calibration with polystyrene calibration part from PSS.
Mₙ: number average molecular weight in [g/mol]
M_{w}: weight average molecular weight in [g/mol]

### Spraying aid S1

### Reactants:

a) phenol,
b) concentrated sulfuric acid,
c) glyoxal.

### Procedure:

275.40 g of phenol are initially taken in a stirred apparatus and 338.6 g of concentrated sulfuric acid (96% by weight) are added in the course of 20 minutes. It is ensured that the temperature does not exceed 105° C. The reaction mixture is then stirred for 30 min at from 100 to 105° C. (sulfonation reaction). The reaction mixture is cooled to 50° C. and 145.1 g of a 40% strength by weight aqueous glyoxal solution is added in portions in the course of 90 min while maintaining an internal temperature of from 50 to 55° C. After the end of the addition, 100 g of water are immediately added, heating to 95 to 100° C. is effected and the reaction is allowed to continue for 3 hours at this temperature (condensation reaction). Cooling to 60° C. is effected and a further 162 g of water are added. Thereafter, 241 g of calcium hydroxide are added before the mixture is filtered over a 20 μm sieve. The pH of the aqueous solution thus obtained is 7.8.

### Spraying Aid SV1

137.7 g of phenol are initially taken in a stirred apparatus and 169.3 g of concentrated sulfuric acid (96% by weight) are added in the course of 20 minutes. It is ensured that the temperature does not exceed 105° C. The reaction mixture is then stirred for 30 min at from 100 to 105° C. (sulfonation reaction). The reaction mixture is cooled to 50° C. and 100.7 g of a 30% strength by weight aqueous formaldehyde solution is added in portions in the course of 4 hours while maintaining an internal temperature of from 50 to 55° C. After the end of the addition, 50 g of water are immediately added, heating to 95 to 100° C. is effected and the reaction is allowed to continue for 4 hours at this temperature (condensation reaction). Cooling to 60° C. is effected and a further 802 g of water are added. Thereafter, 130 g of calcium hydroxide are added before the mixture is filtered over a 20 μm sieve. The pH of the aqueous solution thus obtained is 7.9.

| Drying aid | Mₙ [g/mol] | M_{w} [g/mol] | M_{w}/Mₙ |
|---|---|---|---|
| S1 | 654 | 7480 | 11.4 |
| SV1 | 307 | 4400 | 14.3 |

### Preparation of the Polymer Powders According to the Invention and of the Comparative Polymer Powders

For the preparation of the dry polymer powders, the polymer dispersion was diluted to a solids content of 45% and the spraying aid to a solids content of 30%. The spraying aid was then added to the dispersion rapidly and with vigorous stirring. The spray drying was effected in a minor laboratory dryer from GEA Wiegand GmbH (business position of Niro) with atomization using a disk or a binary nozzle at a tower entry temperature of 130° C. and a tower exit temperature of 60° C. (performance: about 2 kg of spray feed/h). Simultaneously with the spray feed, about 2-3% by weight (based on solid polymer mixture) of a finely divided silica were metered as an anticaking agent into the drying chamber. Ratios, the drying conditions and the results thereof are summarized in table 1.

The redispersibility of the polymer powders was investigated as described below: 90 g of demineralized water are weighed into a glass bottle and 10 g of powder are added. The mixture is stirred using Ultra-Turrax for 1 min at 9500 rpm and introduced into a measuring cylinder. The measuring cylinder closed with a plastic stopper is stored without movement for 72 h. The redispersion is then thoroughly shaken and is filtered via a 72 μm sieve. The sieve is stored for 12 h at 80° C. in a drying oven and the percentage of the dry coagulum, based on the amount of powder weighed in (10 g), is determined.

TABLE 1
Assessment of the spray-dried polymer powders

| | | | Yield | | |
|---|---|---|---|---|---|
| | Spraying | Wall | [% | | |
| Powder | aid^{a)} | deposit | by wt.] | Color | Redispersibility^{b),c)} |
| P1 | 10 S1 | slight | 80 | colorless | 0.1% |
| PV1 | 10 SV1 | slight | 78 | red-brown | 0.3% |

Parts by weight of solid spraying aid, based on 100 parts by weight of the dispersion

At 10% solids content after 72 h

Coagulum filtered off over a 72 μm sieve, dried at 80° C. overnight, in comparison with the redispersed powder quantity

### Test in Standard Mortar

The polymer powders are tested in standard mortar for coloration and mechanical strength according to DIN EN 196-1:2005 (B). For this purpose, a plastic-to-cement ratio of 1:10 was chosen and a water/cement ratio of w/c=0.45. The polymer powder was mixed with the standard mortar (25% of white cement CEM I 42.5R, 25% of standard sand EKI, II, Ill). After mixing with water, standard prisms measuring 4×4×16 cm were cast. After 24 hours or 7 days, the bending tensile strength in N/mm² and the compression strength in N/mm² were determined. They are summarized in table 2.

TABLE 2
Testing of the polymer powders in standard mortar

| | Bending | | Bending | | |
|---|---|---|---|---|---|
| | tensile | Compressive | tensile | Compressive | |
| | strength in | strength in | strength in | strength in | |
| | N/mm² after | N/mm² after | N/mm² after | N/mm² after | |
| Standard | storage at RT | storage at RT | storage at | storage at RT | |
| mortar + | for 24 h | for 24 h | RT for 7 d | for 7 d | Color |
| P1 | 2.8 | 8.4 | 5.8 | 20.7 | colorless |
| PV1 | 1.0 | 3.7 | 4.9 | 18.0 | red |

1. A process for drying a polymer dispersion, the process comprising:
contacting
at least one condensate of C₂-C₆-mono- or dialdehyde with at least one selected from the group consisting of a sulfonated phenol, a sulfonated naphthalene, and a sulfonated polynuclear aromatic
with the polymer dispersion, which comprises a polymer.

2. The process of claim 1, wherein the polymer of the polymer dispersion has a glass transition temperature below 115° C.

3. The process of claim 1, wherein the polymer comprises:
a) from 80 to 100% by weight of at least one monomer selected from the group consisting of a vinylaromatic compound, an ester of an α,β-unsaturated C₃-C₆-carboxylic acid with a C₁-C₁₂-alkanol, an ester of an α,β-unsaturated C₄-C₈-dicarboxylic acid with a C₁-C₁₂-alkanol, a vinyl ester of a C₁-C₁₅-carboxylic acid, an allyl ester of a C₁-C₁₅-carboxylic acid, and butadiene; and
b) from 0 to 20% by weight of at least one further monomer which has at least one ethylenically unsaturated bond.

4. The process of claim 3, wherein the at least one monomer a) is selected from the group consisting of n-butyl acrylate, 2-ethylhexyl acrylate, methyl methacrylate, and styrene.

5. The process of claim 3, wherein the at least one monomer b) is selected from the group consisting of (meth)acrylic acid, (meth)acrylamide, (meth)acrylonitrile, acrylamido-2-methylpropanesulfonic acid, vinylpyrrolidone, hydroxyethyl (meth)acrylate, and hydroxypropyl (meth)acrylate.

6. The process of claim 1, wherein the at least one C₂-C₆-mono- and/or dialdehyde is selected from the group consisting of glyoxal, glutaraldehyde, acetaldehyde, propionaldehyde, butyraldehyde, isobutyraldehyde, pentanal, and hexanal.

7. The process of claim 1, wherein the polymer dispersion is aqueous, at least one.

8. The process of claim 1, wherein from 1 to 30% by weight of the at least one condensate, based on the polymer, is employed.

9. The process of claim 1, wherein the drying of the polymer dispersion is effected by spray drying.

10. A polymer powder obtained by the process of claim 1.

11. The polymer powder of claim 10, comprising the at least one condensate.

12. A binder, comprising the polymer powder of claim 10.

13. A mineral binding building material, comprising the polymer powder of claim 10.

14. The mineral binding building material according to claim 13, in the form of a dry mortar formulation consisting of
from 20 to 60% by weight of mineral binder,
from 0.1 to 25% by weight of the polymer powder of claim 10,
up to 25% by weight of at least one customary assistant and/or additive, as a remaining amount.

15. The process of claim 1, carried out in a mineral building material.

16. The process of claim 2, wherein the polymer comprises:
a) from 80 to 100% by weight of at least one monomer selected from the group consisting of a vinylaromatic compound, an ester of an α,β-unsaturated C₃-C₆-carboxylic acid with a C₁-C₁₂-alkanol, an ester of an α,β-unsaturated C₄-C₈-dicarboxylic acid with a C₁-C₁₂-alkanol, a vinyl ester of a C₁-C₁₅-carboxylic acid, an allyl ester of a C₁-C₁₅-carboxylic acid, and butadiene; and
b) from 0 to 20% by weight of at least one further monomer which has at least one ethylenically unsaturated bond.

17. The process of claim 16, wherein the at least one monomer a) is selected from the group consisting of n-butyl acrylate, 2-ethylhexyl acrylate, methyl methacrylate, and styrene.

18. The process of claim 16, wherein the at least one monomer b) is selected from the group consisting of (meth)acrylic acid, (meth)acrylamide, (meth)acrylonitrile, acrylamido-2-methylpropanesulfonic acid, vinylpyrrolidone, hydroxyethyl (meth)acrylate, and hydroxypropyl (meth)acrylate.

19. The process of claim 18, wherein the at least one monomer b) is selected from the group consisting of (meth)acrylic acid, (meth)acrylamide, (meth)acrylonitrile, acrylamido-2-methylpropanesulfonic acid, vinylpyrrolidone, hydroxyethyl (meth)acrylate, and hydroxypropyl (meth)acrylate.

20. The process of claim 2, wherein the at least one C₂-C₆-mono- and/or dialdehyde is selected from the group consisting of glyoxal, glutaraldehyde, acetaldehyde, propionaldehyde, butyraldehyde, isobutyraldehyde, pentanal, and hexanal.
